(19) United States
(12) Patent Application Publication
(10) Pub. No.: US 2026/0277205 A1
(43) Pub. Date: Sep. 17, 2026

(54) HISTORY MANAGEMENT DEVICE

(71) Applicant: FANUC CORPORATION, Yamanashi (JP)

(72) Inventors: Zeyuan SUN, Yamanashi (JP); Yuta NAMIKI, Yamanashi (JP)

(21) Appl. No.: 19/474,186

(22) PCT Filed: May 24, 2023
(86) PCT No.: PCT/JP2023/019298

§ 371 Date: Oct. 10, 2025

(51) Int. Cl. G05B 23/02

(52) U.S. Cl. CPC G05B 23/0216

(57) ABSTRACT

This history management device comprises a display unit, and a history display control unit that displays, on the display unit, two or more pieces of history information relating to a result of executing a predetermined process by an industrial machine together with statistical information relating to the two or more pieces of history information.

### FIELD

The present disclosure relates to a history management device.

### BACKGROUND

A robot system for detecting a workpiece by a visual sensor mounted on a robot and performing work such as picking up the workpiece has been known. In such a robot system, execution history data are output when an operation program is executed, and are used for performing an analysis related to an execution result. In relation to storage of an execution history in a machine system, for example, PTL 1 describes a molding machine management system for storing and displaying history data including inspection result data and the like regarding a molded product formed by an injection molding machine. PTL 2 describes a picking robot system configured to collect and accumulate data representing results of operations of a picking robot.

### CITATION LIST

### Patent Literature

[PTL 1] Japanese Unexamined Patent Publication (Kokai) No. 2022-170960 A

[PTL 2] Japanese Unexamined Patent Publication (Kokai) No. 2020-040159 A

### SUMMARY

### Technical Problem

In general, in order to analyze an execution history collected in a robot system configured to detect a workpiece by a visual sensor and perform a predetermined operation based on the detection result, the execution history data needs to be output from the robot system in a general-purpose format such as a text file format so that the execution history data can be analyzed using application software running on a personal computer. However, such work requires a considerable amount of effort and time for an operator. A history management device that allows an operator to appropriately and efficiently analyze an execution history output from a machine system is desired.

### Solution to Problem

An aspect of the present disclosure is a history management device including: a display unit; and a history display control unit configured to display, on the display unit, two or more pieces of history information regarding an execution result of predetermined processing by an industrial machine together with statistical information regarding the two or more pieces of history information.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system including a history management device according to one embodiment.

FIG. 2 is a functional block diagram related to a robot controller and an image processing device.

FIG. 3 is a diagram illustrating an example of a history display screen generated by a history display control unit and displayed on a display unit.

FIG. 4 is a diagram illustrating a situation where one of statistics is selected in the history display screen and history information corresponding to the statistic is highlighted.

FIG. 5 is a diagram illustrating a situation where one piece of history information is selected in the history display screen and a statistic corresponding to the history information is highlighted.

FIG. 6 is a diagram illustrating a situation where, in response to selection of one of statistics in a statistical display region, an operation screen for designating a threshold value or a numerical range related to the statistic is displayed.

FIG. 7 is a diagram illustrating an example of the history information including a history image.

FIG. 8 is a diagram illustrating an example of a setting adjustment screen displayed by a playback function.

FIG. 9 is a flowchart indicating a process of detecting a workpiece and storing the history information in the robot system by execution of a detection program.

FIG. 10 is a flowchart illustrating a basic flow related to display of the history information by the history display control unit.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

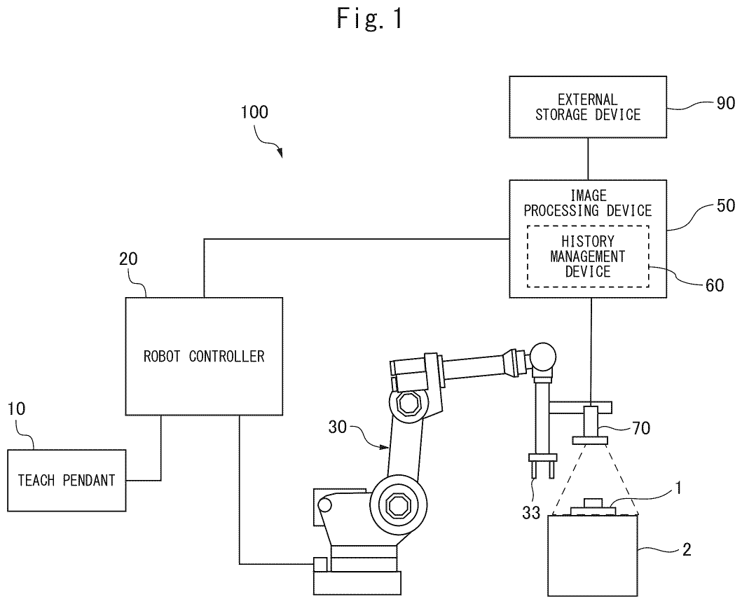

FIG. 1 is a diagram illustrating a configuration of robot system 100 including history management device 60 according to an embodiment. As illustrated in FIG. 1, robot system 100 includes robot 30 including hand 33 mounted on an arm tip portion, robot controller 20 that controls robot 30, teach pendant 10 connected to robot controller 20, visual sensor 70 attached to the arm tip portion of robot 30, image processing device 50, and external storage device 90. Robot system 100 can execute processing such as detection and determination on target object 1 (hereinafter described as workpiece 1) arranged on worktable 2 by visual sensor 70, and perform handling of workpiece 1. Further, robot system 100 has functions of outputting and storing history information as an execution result of work.

In the present embodiment, the function as history management device 60 is incorporated in image processing device 50 having functions of controlling visual sensor 70 and image processing. History management device 60 manages storing of the history information, and also has a function of displaying the history information and information related to the history information.

Robot 30 as an industrial machine is assumed to be a vertical articulated robot herein, but a robot of another kind, for example, an orthogonal coordinate robot, a SCARA robot, and a parallel link robot may be used. Robot controller 20 controls the motion of robot 30 according to a motion program loaded in the robot controller 20 or a command input from teach pendant 10.

Image processing device 50 is connected to robot controller 20, and has a function of performing control of visual sensor 70 and various types of image processing according to a command from robot controller 20. For example, image processing device 50 can detect the position of workpiece 1 from an image captured by visual sensor 70, and provide the detected position of workpiece 1 to robot controller 20. In this way, robot controller 20 can correct a teaching position, and perform picking up and the like of workpiece 1.

Visual sensor 70 may be a camera that captures a gray-scale image or a color image, or may be a stereo camera or a three-dimensional sensor that can acquire a distance image and a three-dimensional point group. Image processing device 50 holds a model pattern of workpiece 1, and can execute the image processing of detecting a workpiece by pattern matching between an image of the workpiece in a captured image and the model pattern. It is assumed that calibration has been performed on visual sensor 70, and it is assumed that image processing device 50 has calibration data that defines a relative positional relationship between visual sensor 70 and robot 30. In this way, a position on an image captured by visual sensor 70 can be converted to a position on a coordinate system (such as a robot coordinate system) fixed in a workspace.

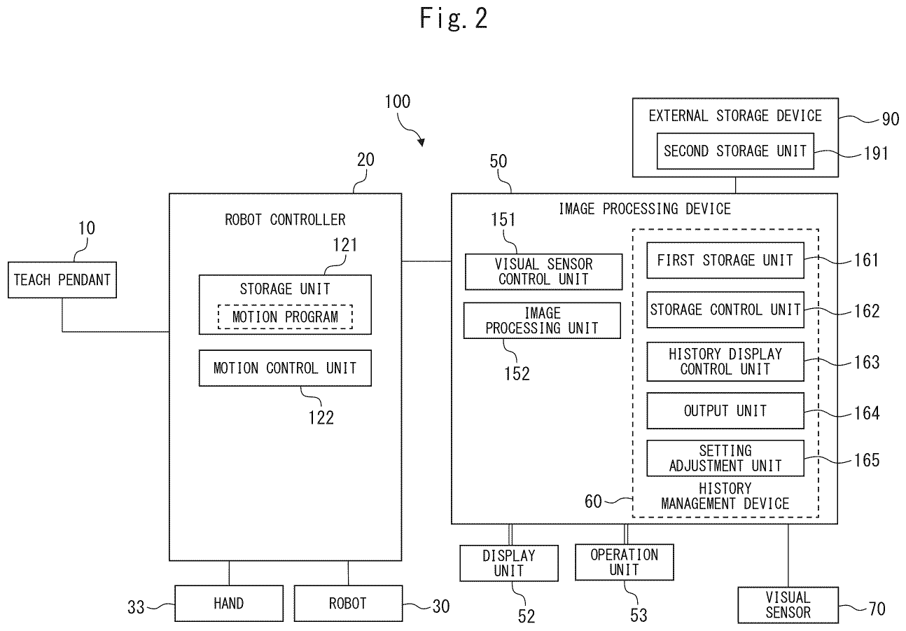

Image processing device 50 may be an apparatus specifically designed for the image processing, or may be formed of a personal computer. Image processing device 50 may have a hardware configuration as a general computer in which a memory (such as a ROM and a RAM (volatile memories), and a non-volatile memory), display unit 52, operation unit 53 formed of an input device such as a keyboard and a mouse, an input/output interface, and the like are connected to a processor via a bus (see FIG. 2). Display unit 52 includes, for example, a liquid crystal display.

Robot controller 20 may have a hardware configuration as a general computer in which a memory (such as a ROM, a RAM, and a non-volatile memory), storage unit 22, an input/output interface, an operation unit including various operation switches, and the like are connected to a processor via a bus.

Teach pendant 10 may have a hardware configuration as a general computer in which a memory (such as a ROM, a RAM, and a non-volatile memory), a display unit, an operation unit formed of an input device such as a keyboard and a touch panel (software key), an input/output interface, and the like are connected to a processor via a bus. It should be noted that various information processing devices such as a tablet computer, a smartphone, and a personal computer may be used as a teaching device instead of the teach pendant 10.

At the time of operation of robot system 100, one or a plurality of workpieces 1 are repeatedly put into robot system 100, and detection and handling of the workpiece are repeatedly performed, so that the history information as a result of execution of each piece of detection processing is stored.

FIG. 2 is a functional block diagram related to robot controller 20 and image processing device 50. As illustrated in FIG. 2, robot controller 20 includes storage unit 22 and motion control unit 121. Storage unit 22 is formed of, for example, a non-volatile memory or a hard disk device, and stores a motion program and various other types of information. Motion control unit 121 controls the motion of robot 30 according to a motion program or a command from teach pendant 10. Motion control unit 121 has functions of interpreting a motion program and the like, planning a trajectory of robot 30, generating a command for controlling each axis of robot 30, and performing servo control of a servo motor of each axis.

Motion control unit 121 can provide machine control information regarding robot 30 to image processing device 50 (history management device 60). The machine control information regarding robot 30 is a position (rotation position) of each joint axis, and a position and a posture of a predetermined control portion (for example, a tool center point (TCP)). Image processing device 50 (history management device 60) can include, in the history information regarding an execution result of processing using visual sensor 70, the machine control information acquired from the robot controller 20.

Image processing device 50 includes visual sensor control unit 151 and image processing unit 152. Visual sensor control unit 151 has a function of controlling visual sensor 70 according to a program related to image processing. Image processing unit 152 has a function of executing various types of image processing such as processing of detecting a position and a posture of a workpiece from a captured image by pattern matching. Visual sensor control unit 151 and image processing unit 152 may be functional blocks achieved by executing a program by the processor of the image processing device 50. Image processing device 50 includes a storage unit (not illustrated) that stores model data used for pattern matching, calibration data, and various other types of information. It should be noted that FIG. 2 illustrates display unit 52 and operation unit 53 as hardware components of image processing device 50.

History management device 60 includes first storage unit 161, storage control unit 162, history display control unit 163, output unit 164, and setting adjustment unit 165. Storage control unit 162, history display control unit 163, output unit 164, and setting adjustment unit 165 of history management device 60 may be functional blocks achieved by executing software (software related to management and display of a history) by the processor of the image processing device 50.

First storage unit 161 is a relatively high-speed memory that stores history information including an execution result of the processing by visual sensor 70 (including a history image, an execution result of processing, a parameter value, and the like) and the machine control information at a time of image-capturing. It should be noted that, when the terms “high speed”, “low speed”, and the like are used to describe performance of a memory, the terms represent a reading/writing speed. First storage unit 161 may be formed of, but not limited to, a volatile memory such as, a DRAM and a SRAM. First storage unit 161 has capacity for storing a plurality of pieces of history information. In this way, since transferring of past history information from first storage unit 161 to second storage unit 191 and deletion of the past history information from first storage unit 161 can be performed concurrently with the processing of current image data captured by visual sensor 70, a delay in the motion of robot system 100 due to the processing related to first storage unit 161 can be suppressed. Further, since the plurality of pieces of history information can be stored, an investigation of a problem caused in the past execution of the processing by visual sensor 70 can be performed by using the stored history information.

Second storage unit 191 of external storage device 90 is a memory having a lower-speed and larger-capacity than those of first storage unit 161. Second storage unit 191 may be formed of, but not limited to, a non-volatile memory such as, a flash memory, a solid state drive (SSD), a hard disk drive, and an optical disk drive. Second storage unit 191 has capacity for storing a plurality of pieces of history information collected during long-term operation of robot system 100. Second storage unit 191 may store the history information transferred from first storage unit 161, or the history information as an execution result of the processing by visual sensor 70 may be directly written to second storage unit 191.

It should be noted that external storage device 90 (second storage unit 191) may be defined as one of the functional components constituting history management device 60.

Storage control unit 162 performs control related to storage of the history information such as storage of the history information by first storage unit 161, storage of the history information by second storage unit 191, and transfer of the history information from first storage unit 161 to second storage unit 191. Storage control unit 162 can store, in first storage unit 161 or second storage unit 191, image data acquired from visual sensor 70, an execution result of the processing (such as detection and determination) using visual sensor 70, the machine control information, and the like in association with one another as one piece of history information.

In the present embodiment, storage control unit 162 may perform storage of the history information by procedures as follows.
(a1) Each time an image processing program (including image-capturing) using the visual sensor is executed, the history information is stored in first storage unit 161.
(a2) When a data amount stored in first storage unit 161 is full or exceeds a predetermined data amount, the history information is transferred to second storage unit 191 in order from the oldest to the newest, and the history information transferred to second storage unit 191 is deleted from first storage unit 161.
   By the procedures described above, the history information temporarily stored in first storage unit 161 can be stored in second storage unit 191 without omission.

History display control unit 163 has a function of displaying, on display unit 52, two or more pieces of history information together with statistical information regarding the two or more pieces of history information. History display control unit 163 can read the history information from first storage unit 161 and second storage unit 191, calculate the statistical information regarding the history information, and display the statistical information together with the history information on display unit 52. Further, history display control unit 163 can display, on display unit 52, two or more pieces of history information satisfying a designated selection condition among the plurality of pieces of history information stored in first storage unit 161 and second storage unit 191, together with the statistical information regarding the two or more pieces of history information.

Output unit 164 has a function of outputting, as a file in a predetermined format, the history information and the statistical information displayed on display unit 52 by history display control unit 163.

Setting adjustment unit 165 has functions of restoring, in response to a predetermined operation performed on the displayed history information, parameters included in the history information to an image processing program (such as a detection program), and displaying a setting adjustment screen for adjusting the program and the parameters.

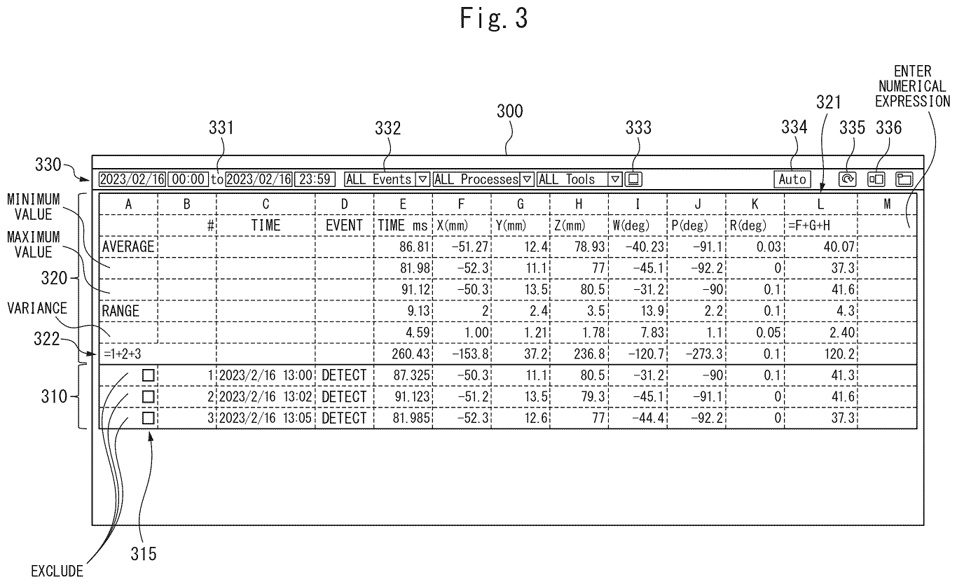

FIG. 3 is a diagram illustrating an example of history display screen 300 generated by history display control unit 163 and displayed on display unit 52. As illustrated in FIG. 3, history display screen 300 includes history display region 310 for displaying the history information, and statistical display region 320 for displaying the statistical information regarding the history information. Further, history display screen 300 includes operation region 330 including a field for designating a selection condition of the history information to be displayed, and various operation buttons.

In history display region 310, the history information satisfying the selection condition designated in operation region 330 is displayed in, for example, chronological order. The size of history display region 310 increases and decreases according to the number of pieces of history information satisfying the selection condition. FIG. 3 illustrates a situation where three pieces of history information are arranged and displayed from top to bottom in order from the newest to the oldest. It should be noted that, when the number of pieces of history information satisfying the selection condition exceeds the number of pieces of history information that can be displayed at the same time in history display screen 300, all of the history information satisfying the selection condition may be displayed in a form of scrolling the screen. In the example of history display screen 300, each piece of history information includes, as display items related to detection results, a time (date and time), an event, time (processing time), and X (mm), Y (mm), Z (mm), W (deg), P (deg), and R (deg) as position/posture information regarding a detected target object.

In statistical display region 320, the statistical information regarding the history information included in history display region 310 (i.e., satisfying the selection condition) is displayed. In the example of history display screen 300, in statistical display region 320, an average value, a minimum value, a maximum value, a range (numerical range), and variance are displayed as a plurality of kinds of statistics related to each of time (processing time), X (mm), Y (mm), Z (mm), W (deg), P (deg), and R (deg) that are the detection results (display items) included in the history information.

It should be noted that the display items of the history information illustrated in FIG. 3 are an exemplification, and various types of information may be included in the history information. For example, a detection number, a detection score, contrast, distortion, an angle, and the like may be included as a detection result in the history information. It should be noted that, herein, the detection number represents a workpiece number detected when the detection processing is executed once. The detection score represents an evaluation value related to a degree of coincidence between a target object on an image and a workpiece model in the detection processing. The contrast represents contrast of an outline of the target object with respect to a background of the image. The distortion represents a degree of distortion of the target object with respect to the workpiece model on the image. The angle represents a deviation in a rotation direction of the target object from the workpiece model on the image. A statistic (an average value, a minimum value, a maximum value, a range (numerical range), and variance) of each of the detection number, the detection score, the contrast, the distortion, and the angle may be included in the statistical information.

Operation region 330 includes a date and time designation field 331 for designating a range of date and time of the history information to be displayed, and an event designation field 332 for designating an event of the history information to be displayed. By designating a range of date and time in the date and time designation field 331, the history information satisfying the designated range of the date and time can be set as a target of display, and can also be set as a target for obtaining the statistical information. The event designation field 332 provides a function of narrowing down pieces of history information to be displayed (that needs to be set as a target of statistical calculation) by accepting designation of the kind of processing (such as detection or determination). It should be noted that designation of all the pieces of history information included in the storage unit (first storage unit 161 and second storage unit 191) as the history information to be displayed is also possible.

Operation region 330 further includes download button 333, automatic update button 334, update button 335, and playback button 336. By pressing download button 333, the history information and the statistical information being displayed are output as a data file in tabular form. When download button 333 is pressed, a screen for designating a device or a folder as an output destination to which a data file is output may be displayed. The function of outputting the history information and the statistical information as a file by pressing download button 333 is provided by output unit 164.

Automatic update button 334 is a button for designating whether to update the history information and the statistical information to be displayed each time new history information is added to first storage unit 161. In other words, automatic update button 334 is a button for designating whether to automatically update the history information and the statistical information in real time. For example, when the date and time are designated in the date and time designation field 331 in such a way that a time range from a certain point in time in the past to a “present point in time” is set as a target of display, and automatic update button 334 is pressed in this state, history display control unit 163 adds new history information to the history display region each time the new history information is added to first storage unit 161, and also updates the statistical information by using the new history information. In a state where automatic update button 334 is not pressed, the automatic update of the history information and the statistical information is not performed. In this way, by the function of updating the history information and the statistical information in real time, a user can always confirm the newest situation regarding an execution result, and can also quickly confirm an execution result after a parameter adjustment of the detection program and the like.

Update button 335 provides a function of updating the history information manually by the user. For example, when the date and time are designated in the date and time designation field 331 in such a way that a time range from a certain point in time in the past to a “present point in time” is set as a target of display, and update button 335 is pressed in a state where automatic update button 334 is not pressed, history display control unit 163 updates the history information and the statistical information to the newest state.

Playback button 336 has functions of restoring various setting parameters included in the history information to a program, and adjusting the program and the parameters. For example, when the user selects desired history information and presses playback button 336, setting adjustment unit 165 restores various setting parameters included in the selected history information to a program, and displays a setting adjustment screen for adjusting the program.

As illustrated in FIG. 3, history display control unit 163 may display the history information and the statistical information in tabular form in the same table. Further, in history display screen 300, values related to the same display item are aligned and displayed in the same column. By such a display form, the user can quickly and appropriately recognize a relationship between each display item of the history information and statistics related to each display item.

It should be noted that, in history display screen 300 in FIG. 3, a plurality of kinds of detection results (display items) included in each piece of the history information are arranged and displayed in a row direction, and a plurality of kinds of statistics related to each of the detection results are arranged and displayed in a column direction at a display position of each of the detection results in the arrangement direction (row direction) of the detection results. As an alternative to such a display form, in history display screen 300, a plurality of kinds of detection results included in each piece of the history information may be arranged and displayed in the column direction, and a plurality of kinds of statistics related to each of the detection results may be arranged and displayed in the row direction at a display position of each of the detection results in the arrangement direction (column direction).

In this way, history display screen 300 is configured to display the history information and the statistical information regarding the history information in the same table, and thus the user can quickly and appropriately recognize the situation regarding the detection accuracy of the detection program and take necessary measures. For example, when a tendency that variations in contrast are great and a detection score is unstable can be recognized in the history information being displayed, the user determines that, for example, lighting has an influence on the execution result and can take measures against the situation by adding lighting and the like. Alternatively, the user may change the parameter of the detection program, based on the statistics included in the statistical information. For example, the user can confirm a minimum value of a detection score, decide a threshold value of the detection score, based on the minimum value, and apply the threshold value to the detection program. Alternatively, the user may set a value defining a range of three sigmas from an average value of a detection score as a threshold value of the detection score of the detection program.

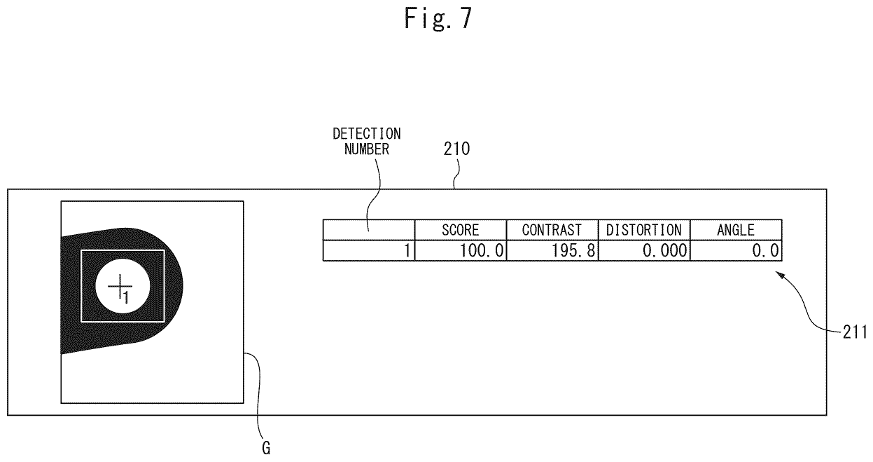

It should be noted that, when each piece of history information displayed in history display region 310 includes additional information such as a history image, the additional information such as the history image may be displayed by selecting the history information and performing a predetermined operation. FIG. 7 illustrates an example of information display screen 210 displayed by selecting one piece of history information included in history display region 310 and performing a predetermined operation. Information display screen 210 includes history image G, and a display field 211 of a detection number, a score (detection score), contrast, distortion, and an angle. Information display screen 210 may be displayed simultaneously with history display screen 300 in a window form or may be displayed alone as a display screen separate from history display screen 300. History display control unit 163 takes charge of the functions related to presentation of information display screen 210.

History display control unit 163 has a function of improving the convenience of the user who checks the displayed history information by associating the statistical information displayed in statistical display region 320 with the history information displayed in history display region 310. For example, history display control unit 163 may have functions as follows.
(F1) A function of highlighting, in response to selection of a statistic (for example, a maximum value) displayed in a field in statistical display region 320, the history information corresponding to the selected statistic (including the selected statistic).
(F2) A function of highlighting, in response to selection of one piece of history information included in history display region 310, a statistic corresponding to the selected history information. For example, when the selected history information includes a detection result (item) having a maximum value as a statistic, the corresponding maximum value in statistical display region 320 is highlighted.

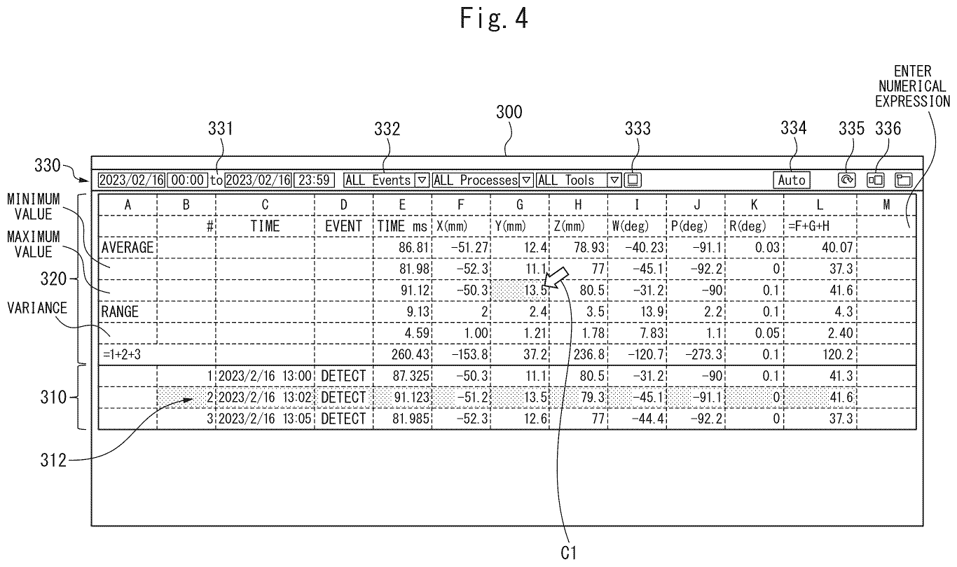

FIG. 4 illustrates a display state where a maximum value “13.5” of the Y value in statistical display region 320 is selected and history information 312 having the maximum value is highlighted by the function (F1) described above. It should be noted that various manners such as a change in a color, a thickness, or a font of a character, and addition of a color or a pattern to a cell may be used as a highlighting manner. As illustrated in FIG. 4 as one example, an operation of selecting one of statistics may be performed by putting cursor C1 on one of statistics and clicking a mouse. In this way, by highlighting, in response to selection of a statistic, the history information corresponding to the statistic, the user can immediately confirm the history information corresponding to the selected statistic (such as a maximum value). Further, the user can also immediately perform a parameter adjustment of history information 312 by pressing playback button 336 in a state where history information 312 is highlighted.

It should be noted that, when the history information corresponding to a selected statistic includes additional information such as a history image in the function (F1), a transition to an information display screen that displays all the contents of history information including the history image may be made in response to selection of the statistic.

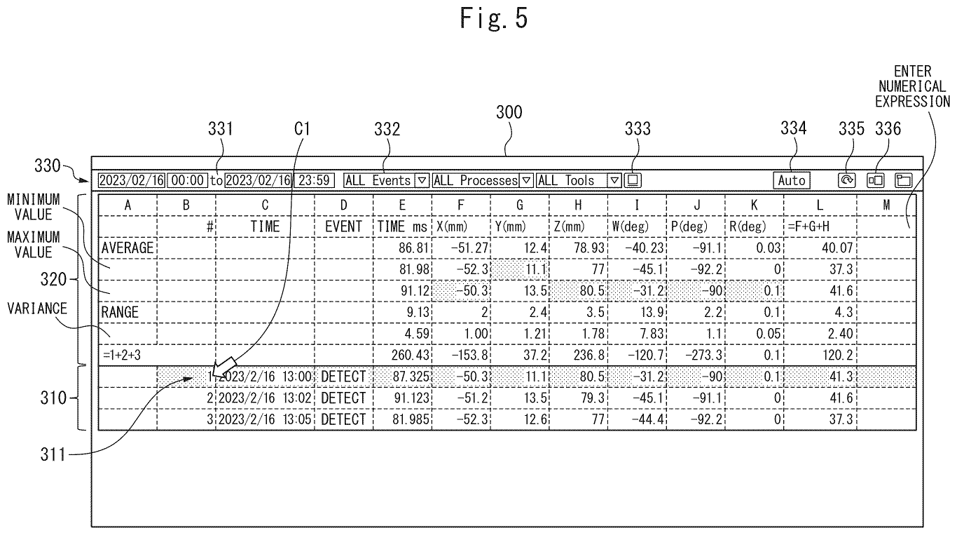

FIG. 5 illustrates a situation where, in response to selection of history information 311 in history display region 310, a statistic corresponding to a detection result (display item) included in history information 311 is highlighted by the function (F2) described above. As illustrated in FIG. 5 as one example, an operation of selecting one piece of history information may be performed by putting cursor C1 on one piece of history information and clicking the mouse. Herein, in the selected history information 311, the Y value (“11.1”) is statistically a minimum value, and the X value (“−50.3”), the Z value (“80.5”), the W value (“−31.2”), the P value (“−90”), and the R value (“0.1”) are statistically a maximum value, and thus these statistics are highlighted. In this case, the user can immediately confirm the fact that the selected history information includes a statistically characteristic value (the maximum value or the minimum value in this case).

History display control unit 163 may further have a function (F3) as follows. (F3) A function of displaying, in response to selection of a statistic included in the statistical information, an operation screen for accepting an operation of designating a threshold value (or a numerical range) related to the selected statistic, and highlighting the history information selected by the threshold value (or the numerical range) designated via the operation screen from among the history information displayed in history display region 310.

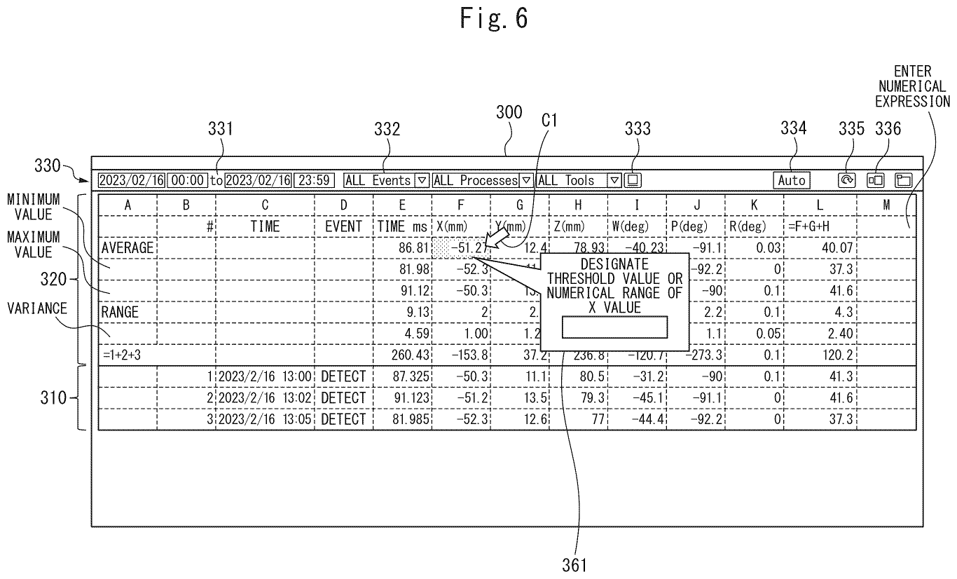

FIG. 6 illustrates a situation where, in response to selection of “average value of X” included in the statistical information, operation screen 361 for designating a threshold value related to the statistic is displayed by the function (F3). Operation screen 361 may be displayed by, for example, putting cursor C1 on a statistic, and performing a specific operation (operation of selecting an operation screen from a menu appearing by a right click). Operation screen 361 is configured to accept designation of a threshold value related to the X value. For example, when the user designates a threshold value for the X value as “+10 from average value” via operation screen 361, history display control unit 163 may highlight the history information whose X value exceeds the designated threshold value (+10) (in a case of a negative value, an absolute value thereof is greater than an absolute value of the threshold value (−10)) among the history information included in history display region 310.

According to the function (F3), for example, the user can quickly confirm a group of pieces of history information whose statistics are greater than a specific value, a group of pieces of history information whose statistics are smaller than a specific value, or a group of pieces of history information whose statistics fall within a specific numerical range. Further, the user can also immediately perform a parameter adjustment by the playback function as necessary on the highlighted history information. In this way, the function of searching for the history information by a selection condition related to statistics is provided by the function (F3).

History display control unit 163 may further have a function (F4) for displaying the statistical information calculated by a numerical expression being uniquely set by the user. In history display screen 300 in FIG. 3, as an exemplification, a state where a numerical expression (F column+G column+H column) is set by the user in an L-th column (indicated by reference sign 321) by the function (F4), and a calculation result by the numerical expression is displayed in the L-th column is illustrated. Further, in history display screen 300 in FIG. 3, as an exemplification, a situation where a numerical expression for calculating a total value of numerical data of each display item of first to third history information is designated in a row indicated by reference sign 322 is illustrated. By the numerical expression, in each of columns from the E-th column to the L-th column in the row indicated by reference sign 322, a total value of numerical values in each column of the first to third history information is displayed. The statistical information calculated by the numerical expression set by the user is also included in output data being output by pressing download button 333.

History display control unit 163 may have a function (F5) capable of excluding the history information included in the history display region 310 from a target of calculation for obtaining the statistical information in statistical display region 320. For example, as illustrated in FIG. 3, check box 315 for designating exclusion from the statistical calculation may be added to each piece of history information. In this case, history display control unit 163 excludes the history information whose check box 315 is checked from a target of the statistical calculation, and recalculates and displays the statistical information. According to such a function (F5), the user can exclude specific history information (for example, history information in which a detection position is greatly deviated from the other history information) selected by viewing the statistical information, and update the statistical information.

In this way, by the history display function provided via history display screen 300 as a user interface, the user can evaluate an execution history, based on information on which the user focuses. Further, by the function of setting a numerical expression, the history information can be evaluated by an evaluation criterion uniquely set by the user. In other words, history display screen 300 is customizable.

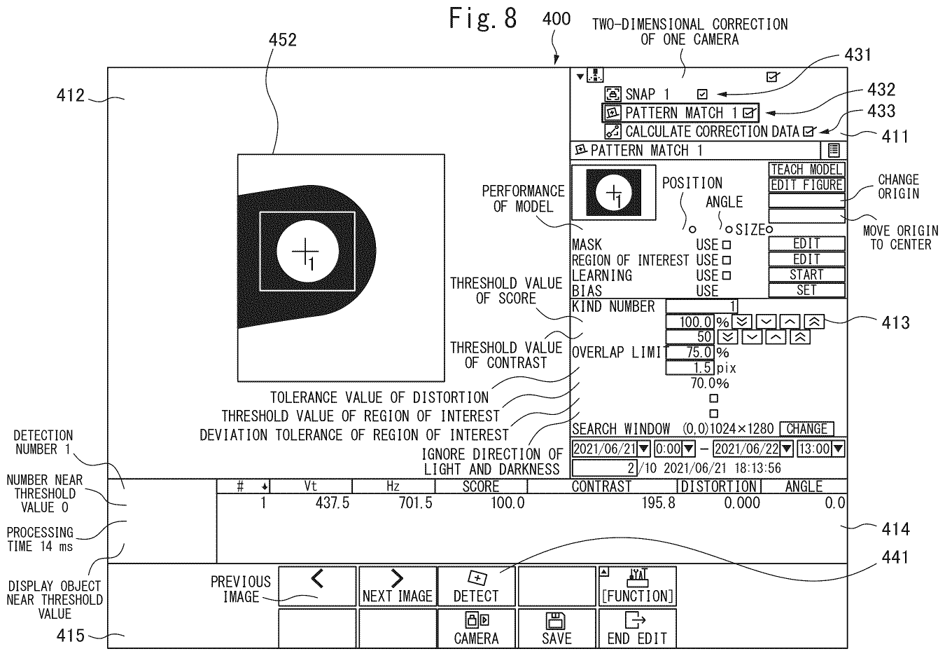

As described above, history display control unit 163 has the functions of restoring a parameter included in the history information displayed in history display region 310 to a program in response to playback button 336 being pressed in a state where one piece of history information is selected or highlighted, and displaying the setting adjustment screen for adjusting the program and the parameter. FIG. 8 illustrates an example of setting adjustment screen 400 displayed in response to playback button 336 being pressed in a state where one piece of history information displayed in history display region 310 is selected or highlighted. As illustrated in FIG. 8, setting adjustment screen 400 includes detection program display region 411 for displaying a detection program, image display region 412 for displaying a history image, parameter display region 413, detection result display region 414, and operation button display region 415 for displaying various operation buttons.

As one example, a detection program having a name of “two-dimensional correction of one camera” is displayed in detection program display region 411. The detection program includes snapshot icon 431, pattern match icon 432, and correction data calculation icon 433. Snapshot icon 431 represents a command for executing image-capturing by visual sensor 70. Pattern match icon 432 represents a command for performing detection of a workpiece on a captured image by a pattern matching. Correction data calculation icon 433 represents a command for calculating correction data for correcting a teaching position, based on a position of the workpiece acquired by the pattern matching.

In the first stage of a transition from history display screen 300 to setting adjustment screen 400, history image 452 of the history information selected or highlighted on history display screen 300 is displayed in image display region 412.

In parameter display region 413, parameters of the detection program restored from the history information selected or highlighted on history display screen 300 are displayed. FIG. 8 illustrates a state where pattern match icon 432 is selected in detection program display region 411, and various parameters related to pattern match icon 432 are displayed in parameter display region 413. The parameters of pattern match icon 432 include a threshold value of a score, a threshold value of contrast, and various other parameters. By selecting the other icon in detection program display region 411, parameters (restored parameters) for the selected icon can be displayed in parameter display region 413 and adjusted.

In detection result display region 414, a processing result of the detection program is displayed. FIG. 8 illustrates a state where a detection result (such as a detection number, a position, a score, and contrast) included in the history information selected or highlighted on history display screen 300 is displayed in detection result display region 414.

Operation buttons for performing various operations are displayed in operation button display region 415. By adjusting various parameters in parameter display region 413 and then pressing detection button 441, the detection program can be executed by new parameters, and a result of the execution can be confirmed.

In this way, the user is allowed to restore parameters to a program from history display screen 300, and also cause the transition to setting adjustment screen 400 on which the parameters can be adjusted. In history display screen 300, the history information and the statistical information are associated with each other, and thus the user is allowed to select the history information that needs an adjustment by checking the statistical information, so that the transition to a parameter adjustment screen for adjusting parameter values of the selected history information can be made smoothly.

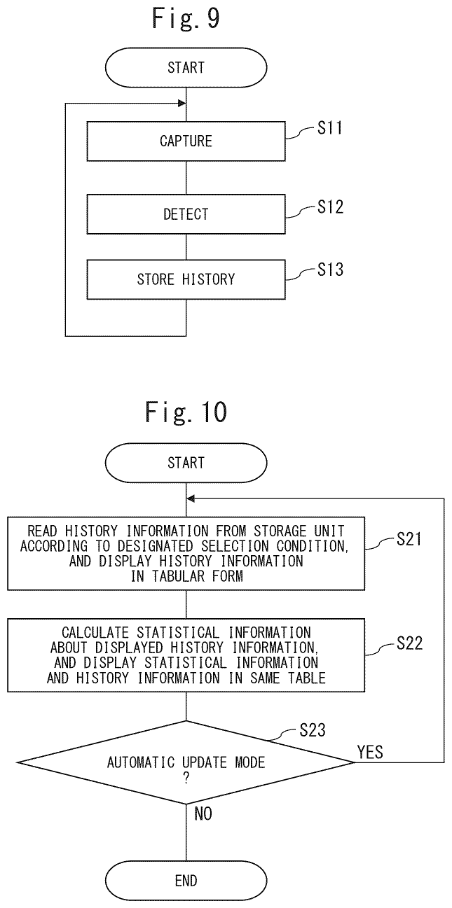

FIG. 9 is a flowchart illustrating a process of detecting workpiece 1 by execution of a detection program and storing history information in robot system 100. As illustrated in FIG. 9, image-capturing of workpiece 1 by visual sensor 70 is performed by execution of the detection program (step S11). Then, detection processing by image processing unit 152 of image processing device 50 is executed (step S12). A detection result (detection position of workpiece 1) is used for control of robot 30 by motion control unit 121. Next, storage of the history information into the storage unit (first storage unit 161 and second storage unit 191) is performed by the above-described storage functions (procedures (a1) and (a2)) of storage control unit 162 of history management device 60 (step S13). A workpiece is repeatedly put into robot system 100, and the present processing is repeatedly executed accordingly. In this way, the history information is accumulated in and newest history information is added to the storage unit (first storage unit 161 and second storage unit 191).

FIG. 10 is a flowchart illustrating a basic flow related to display of the history information by history display control unit 163. The present processing (history display processing) is executed under control by the processor of history management device 60 (processor of image processing device 50 in the present embodiment). The history display processing is started by, for example, a predetermined operation of designating history display on history management device 60 (image processing device 50). History display control unit 163 reads the history information from the storage unit (first storage unit 161 and second storage unit 191) according to a selection condition designated in the date and time designation field 331 and the like, and displays the history information in history display region 310 of history display screen 300 (step S21).

Next, history display control unit 163 calculates the statistical information regarding the displayed history information, and displays the calculated statistical information in the same table as that of the history information (step S22).

When the automatic update mode of updating the history information in real time is designated by pressing of automatic update button 334 (S23: YES), history display control unit 163 repeats the processing of reading the history information from the storage unit according to a selection condition to update the history information and the statistical information (steps S21 and S22). It should be noted that the “automatic update mode” in step S23 corresponds to a case where an operation for displaying histories up to the present is performed on date and time designation field 331, and automatic update button 334 is pressed. When the automatic update mode is not designated (S23: NO), the present processing is ended. Thereafter, the present history display processing may be started in response to occurrence of various events (such as an operation of designating a selection condition in operation region 330, an operation of pressing update button 335, and an operation of pressing automatic update button 334) based on which the present history display processing should be invoked.

The embodiment described above is a configuration example in which the robot system includes a visual sensor as a sensor and the history information relates to a result of the detection processing based on an image captured by the visual sensor. The embodiment described above can also be applied to a case in which the robot system includes various sensors, and the history information includes at least one of an output of the sensor and a result of processing based on the output of the sensor. For example, a case where the robot system is configured to include a force sensor mounted between a flange of a robot arm tip and a tool (such as a hand) and to execute a force control program, based on a detection value of the force sensor is assumed. The force sensor outputs an external force acting on a robot (tool) as a detection value. The force control program in this case may include a program for performing precision fitting, polishing work, and the like. A controller functioning as the history management device in the robot system executes the force control program, and records the history information as an execution result. The history information in this case may include an execution start date and time, a force control program name, a position where force control is performed (position of a control point), a detection value of the force sensor in the position (force and moment in each axis direction), and the like. It should be noted that parameters (force control parameters) of the force control program include, for example, a target pressing force, a force control gain, and the like. For example, for a plurality of pieces of history information (detection values) recorded by executing the force control program for a plurality of times, the controller can calculate the statistical information and display the statistical information together with the history information as in the embodiment described above. It should be noted that a torque sensor arranged on each axis of a robot (tool) may be used as a sensor for detecting an external force acting on the robot instead of the force sensor.

The configuration of the embodiments described above can be applied to displaying of the history information output by executing operations in an industrial machine system in which measurement by various sensors is performed.

In the above embodiments, the configuration when the function as history management device 60 is embedded in image processing device 50 is described. However, the configuration is one example, and a configuration example in which the function as history management device 60 is embedded in robot controller 20 is also possible. A configuration example in which the entire function of image processing device 50 including the function as history management device 60 is embedded in robot controller 20 is also possible. When the function as history management device 60 is embedded in robot controller 20, the functional blocks constituting history management device 60 may be arranged in the robot controller, and external storage device 90 may be connected to robot controller 20. In this case, history display control unit 163 may display various screens such as the history display screen on the display unit of teach pendant 10, and accept an input on the history display screen and the like via the operation unit of teach pendant 10 (or a touch panel screen integrated with the display unit, and the like).

Alternatively, the function as history management device 60 may be embedded in teach pendant 10. In this case, the functional blocks of history management device 60 are arranged in teach pendant 10. Then, external storage device 90 may be connected to teach pendant 10.

The embodiments described above exemplify the configuration in which external storage device 90 as second storage unit 191 is connected to history management device 60; however, a non-volatile memory functioning as second storage unit 191 may be included in history management device 60.

The functional blocks of the history management device illustrated in FIG. 2 may be achieved by executing various types of software stored in a storage device by one or the plurality of processors of the history management device, or may be achieved by a configuration in which hardware such as an application specific integrated circuit (ASIC) is a main body.

The program for executing various types of processing related to history management such as the history display processing in the embodiments described above can be recorded in various computer-readable recording media (for example, a ROM, an EEPROM, a semiconductor memory such as a flash memory, a magnetic recording medium, and an optical disk such as a CD-ROM and a DVD-ROM).

As described above, according to each of the embodiments, a worker can appropriately and efficiently analyze execution history information output from a machine system.

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can also be executed in combination. For example, in the embodiments described above, an order of operations and an order of pieces of processing are indicated as one example, which is not limited thereto. Further, the same also applies to a case where a numerical value or a numerical expression is used in the description of the embodiments described above.

With regard to the embodiments and the modification examples described above, supplementary notes below are further described.

### SUPPLEMENTARY NOTE 1

A history management device (60) including: a display unit (52); and a history display control unit (163) configured to display, on the display unit (52), two or more pieces of history information regarding an execution result of predetermined processing by an industrial machine together with statistical information regarding the two or more pieces of history information.

### SUPPLEMENTARY NOTE 2

The history management device (60) according to supplementary note 1, further including a storage unit (161, 191) configured to store a plurality of pieces of history information regarding an execution result of predetermined processing by the industrial machine, wherein the history display control unit (163) is configured to display the two or more pieces of history information satisfying a designated selection condition among the plurality of pieces of history information stored in the storage unit (161, 191), and the statistical information regarding the two or more pieces of history information.

### SUPPLEMENTARY NOTE 3

The history management device (60) according to supplementary note 1 or 2, wherein the statistical information includes a plurality of kinds of statistics related to at least one item included in each piece of history information.

### SUPPLEMENTARY NOTE 4

The history management device (60) according to any one of supplementary notes 1 to 3, wherein the history display control unit (163) is configured to display the two or more pieces of history information and the statistical information regarding the two or more pieces of history information in the same table.

### SUPPLEMENTARY NOTE 5

The history management device (60) according to supplementary note 4, wherein, in the table, a plurality of kinds of items included in each piece of history information are arranged and displayed in one direction of a row direction and a column direction, and a plurality of kinds of statistics related to each of the items are arranged and displayed in the other direction of the row direction and the column direction at a display position of each of the items in an arrangement direction of the items.

### SUPPLEMENTARY NOTE 6

The history management device (60) according to any one of supplementary notes 1 to 5, wherein the history display control unit (163) is configured to highlight, in response to an operation of selecting one statistic included in the statistical information, the history information corresponding to the selected one statistic among the displayed two or more pieces of displayed history information.

### SUPPLEMENTARY NOTE 7

The history management device (60) according to any one of supplementary notes 1 to 6, wherein the history display control unit (163) is configured to highlight, in response to an operation of selecting one piece of history information among the displayed two or more pieces of history information, a statistic in the statistical information corresponding to the selected one piece of history information.

### SUPPLEMENTARY NOTE 8

The history management device (60) according to any one of supplementary notes 1 to 7, wherein the history display control unit (163) is configured to display, in response to an operation of selecting one statistic included in the statistical information, an operation screen for designating a threshold value or a numerical range related to the selected one statistic on the display unit, and highlight the history information selected by the designated threshold value or the designated numerical range related to the selected one statistic among the displayed two or more pieces of history information.

### SUPPLEMENTARY NOTE 9

The history management device (60) according to any one of supplementary notes 1 to 8, wherein the history display control unit (163) is configured to accept designation of a numerical expression using numerical data included in the statistical information or the history information, and display a calculation result by the designated calculation expression.

### SUPPLEMENTARY NOTE 10

The history management device (60) according to any one of supplementary notes 1 to 9, wherein the history display control unit (163) is configured to accept an operation of designating the history information to be excluded from a target of calculation of the statistical information among the displayed two or more pieces of displayed history information.

### SUPPLEMENTARY NOTE 11

The history management device (60) according to supplementary note 2, wherein new history information is stored in the storage unit (161, 191) each time the predetermined processing is executed by the industrial machine, and the history display control unit (163) is configured to additionally display, in response to addition of new history information satisfying the designated selection condition to the storage unit, the new history information on the display unit, and updates the statistical information, based on the new history information.

### SUPPLEMENTARY NOTE 12

The history management device (60) according to any one of supplementary notes 1 to 11, further including an output unit (164) configured to output, as a file in a predetermined format, the two or more pieces of history information and the statistical information being displayed on the display unit.

### SUPPLEMENTARY NOTE 13

The history management device (60) according to any one of supplementary notes 1 to 12, further including a setting adjustment unit (165) configured to restore, in response to a predetermined operation being performed in a state where one piece of history information is selected or highlighted in the display unit (52), a parameter included in the one piece of history information to a program, and displays a setting adjustment screen for adjusting the program and the parameter on the display unit.

### SUPPLEMENTARY NOTE 14

The history management device (60) according to any one of supplementary notes 1 to 13, wherein the predetermined processing executed by the industrial machine includes processing using a sensor, and the history information includes an output from the sensor, or at least one result of processing the output from the sensor.

### SUPPLEMENTARY NOTE 15

The history management device (60) according to supplementary note 14, wherein the sensor is a visual sensor (70), and the history information includes an execution result of detection using the visual sensor (70).

### REFERENCE SIGNS LIST

1 Workpiece
2 Worktable
10 Teach pendant
20 Robot controller
22 Storage unit
30 Robot
33 Hand
50 Image processing device
52 Display unit
53 Operation unit
60 History management device
70 Visual sensor
90 External storage device
100 Robot system
151 Visual sensor control unit
152 Image processing unit
161 First storage unit
162 Storage control unit
163 History display control unit
164 Output unit
165 Setting adjustment unit
191 Second storage unit
300 History display screen
310 History display region
320 Statistical display region
330 Operation region
400 Setting adjustment screen
411 Detection program display region
412 Image display region
413 Parameter display region
414 Detection result display region
415 Operation button display region

1. A history management device comprising:
a display unit; and
a history display control unit configured to display, on the display unit, two or more pieces of history information regarding an execution result of predetermined processing by an industrial machine together with statistical information regarding the two or more pieces of history information.

2. The history management device according to claim 1, further comprising
a storage unit configured to store a plurality of pieces of history information regarding an execution result of predetermined processing by the industrial machine, wherein
the history display control unit is configured to display the two or more pieces of history information satisfying a designated selection condition among the plurality of pieces of history information stored in the storage unit, and the statistical information regarding the two or more pieces of history information.

3. The history management device according to claim 1, wherein
the statistical information includes a plurality of kinds of statistics related to at least one item included in each piece of history information.

4. The history management device according to claim 1, wherein
the history display control unit is configured to display the two or more pieces of history information and the statistical information regarding the two or more pieces of history information in the same table.

5. The history management device according to claim 4, wherein,
in the table, a plurality of kinds of items included in each piece of history information are arranged and displayed in one direction of a row direction and a column direction, and a plurality of kinds of statistics related to each of the items are arranged and displayed in the other direction of the row direction and the column direction at a display position of each of the items in an arrangement direction of the items.

6. The history management device according to claim 1, wherein
the history display control unit is configured to highlight, in response to an operation of selecting one statistic included in the statistical information, the history information corresponding to the selected one statistic among the displayed two or more pieces of history information.

7. The history management device according to claim 1, wherein
the history display control unit is configured to highlight, in response to an operation of selecting one piece of history information among the displayed two or more pieces of history information, a statistic in the statistical information corresponding to the selected one piece of history information.

8. The history management device according to claim 1, wherein
the history display control unit is configured to display, in response to an operation of selecting one statistic included in the statistical information, an operation screen for designating a threshold value or a numerical range related to the selected one statistic on the display unit, and highlight the history information selected by the designated threshold value or the designated numerical range related to the selected one statistic among the displayed two or more pieces of history information.

9. The history management device according to claim wherein
the history display control unit is configured to accept designation of a numerical expression using numerical data included in the statistical information or the history information, and display a calculation result by the designated calculation expression.

10. The history management device according to claim 1, wherein
the history display control unit is configured to accept an operation of designating the history information to be excluded from a target of calculation of the statistical information among the displayed two or more pieces of displayed history information.

11. The history management device according to claim 2, wherein
new history information is stored in the storage unit each time the predetermined processing is executed by the industrial machine, and
the history display control unit is configured to additionally display, in response to addition of new history information satisfying the designated selection condition to the storage unit, the new history information on the display unit, and update the statistical information, based on the new history information.

12. The history management device according to claim 1, further comprising
an output unit configured to output, as a file in a predetermined format, the two or more pieces of history information and the statistical information being displayed on the display unit.

13. The history management device according to claim 1, further comprising
a setting adjustment unit configured to restore, in response to a predetermined operation being performed in a state where one piece of history information is selected or highlighted in the display unit, a parameter included in the one piece of history information to a program, and display a setting adjustment screen for adjusting the program and the parameter on the display unit.

14. The history management device according to claim 1, wherein
the predetermined processing executed by the industrial machine includes processing using a sensor, and
the history information includes an output from the sensor, or at least one result of processing the output from the sensor.

15. The history management device according to claim 14, wherein
the sensor is a visual sensor, and
the history information includes an execution result of detection using the visual sensor.
